(19) United States
(12) Patent Application Publication
(10) Pub. No.: US 2012/0219848 A1
(43) Pub. Date: Aug. 30, 2012

(54) GALVANIC ELEMENT AS A DEVICE BATTERY

(75) Inventor: Volker Seefeldt, Marsberg (DE)

(73) Assignee: H & T MARSBERG GMBH & CO. KG, MARSBERG (BREDELAR) (DE)

(21) Appl. No.: 13/503,360

(22) PCT Filed: Jul. 16, 2010
(86) PCT No.: PCT/EP10/04341

§ 371 Date: Apr. 20, 2012

(30) Foreign Application Priority Data
Oct. 20, 2009 (DE) 10 2009 049 890.7

(51) Int. Cl. H01M 2/02; C25D 5/02

(52) U.S. Cl. 429/164; 205/122

(57) ABSTRACT

An improved housing for a galvanic element as a device battery, features an outer cup made of metal or plastic, which outer cup is coated, in particular galvanically, on the inside and outside with nickel or tin or cobalt or with an alloy containing nickel/cobalt, wherein the outer coating is arranged only in the two end areas of the cup, and the outer intermediate area between the two end areas does not have a coating. A method of making the device battery includes the steps of first, forming a substrate into a cylindrical cup shape, then coating all of the cup interior, but only exterior end regions of the cup with a coating of tin, nickel, or cobalt or a nickel- or cobalt-containing alloy, and finally applying an insulating layer along the entire axial exterior length of the cup, leaving the cup bottom free for use as a contact area. Leaving an exterior intermediate region uncoated conserves coating or plating material.

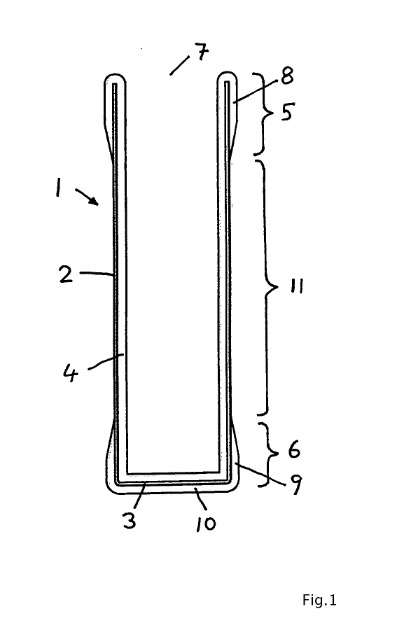

### CROSS-REFERENCE TO RELATED APPLICATIONS

This application is a section 371 of International Application PCT/EP2010/04341, filed 16 Jul. 2010, published 28 Apr. 2011 as WO 2011-047742-A1, and further claims priority from German application DE 10 2009 049 890.1 filed 20 Oct. 2009, the entire disclosure of which is incorporated by reference.

### FIELD OF THE INVENTION

The invention relates to a housing for a galvanic element as a device battery with an external cup of metal or plastic which is coated inside and outside, particularly galvanically, with nickel or tin or cobalt or with a nickel- or cobalt-containing alloy. Further, the invention relates to a method of making a housing for a galvanic element.

### BACKGROUND

Cup-shaped hollow bodies, having a closed floor or bottom, are used as housings for galvanic elements (device batteries). Due to corrosion reasons, and for reasons of improved contacting, these housings have a galvanic surface coating or plating of nickel or of a nickel/cobalt coating. In this context, it is known to make the housings either by a deep-drawing process from galvanically nickel-coated or nickel/cobalt-coated sheet (NPS) or to bring an uncoated deep-drawing-capable sheet metal into housing form, and to thereafter galvanically coat the sheet metal as bulk goods.

The cylindrical part of the housing must also, in a further process, be externally insulated for manufacture of a battery. Such insulation is achieved by use of a self-adhering plastic or by a shrunk-fit sleeve. Regardless of which insulating method is used, the housing is always galvanically coated over its entire surface.

### SUMMARY OF THE INVENTION

An object of the invention is to improve a galvanic element of the aforementioned type, so that material is conserved or saved, and manufacture is simplified.

This object is achieved, according to the invention, in that the external coating is arranged only in both end regions of the cup, and the exterior intermediate region, between both end regions, is free of a coating.

In this way, a substantial amount of coating material is saved. The teaching of the present invention takes advantage of the fact that, for the functioning of the housing of a galvanic element, it is, in principle, only necessary to nickel-coat the pole regions, in order to assure trouble-free contacting.

Advantageously, it is proposed that the lengths of the respective end region coatings approximate 1/20 to ⅓ of the entire axial length of the cup.

It is further proposed that the thicknesses of the coatings inside and outside be made different. Further, the coating materials of the coatings inside and outside can be different.

The uncoated regions can either remain untreated, or can be protected from corrosion by various measures, such as by application of a rust-protection medium. From a functional standpoint, it is advantageous if the outside of the cup is coated with an insulating layer over the entire length of the cup, up to the contacts, the layer also covering the two end region coatings. The insulating layer can comprise a varnish or lacquer and/or an adhesive label and/or a plastic shrunk-fit, or a combination thereof.

The aforementioned advantages make themselves strongly apparent, according to the present invention for making a housing for a galvanic element, in which, after constructing the cup of metal or plastic, the cup is completely coated inside and partly coated outside, such that only the two exterior end regions are coated, particularly galvanically, with nickel or tin or cobalt or with a nickel- or cobalt-containing alloy, an intermediate region, between the cup end regions, remaining free of coating. The lengths of the respective end region coatings are about 1/20 to ⅓ of the complete axial length of the cup; thereafter, the cup exterior, over the entire length of the cup, up to the contacts, is covered by an insulating layer, which layer is also superimposed upon both end region layers.

In the housing and cup according to the invention, and especially in the case of the manufacturing process, one can advantageously use the apparatus and the surface treatment process which are known from US 2006/0118411, SEEFELDT & GUSTAR, published 8 Jun. 2006, and corresponding WO 2006-061,659-A1, published 15 Jun. 2006.

### BRIEF FIGURE DESCRIPTION

An exemplary embodiment of the invention is shown in the drawing by an axial longitudinal section, and is more fully described in the following.

### DETAILED DESCRIPTION

The housing of a galvanic element features a cup 1 having a cylindrical, tubular sidewall 2, closed at one end by a formed-on bottom or floor 3. The sidewall and bottom are composed of metal or plastic. All inner surfaces of the housing have a gap-free inner coating 4 of nickel or tin or cobalt or of a nickel- or cobalt-containing alloy, particularly of a nickel-cobalt alloy.

The exterior of the container also has a coating of this material. This outer coating, however, covers only both end regions 5,6 of the cup-shaped container, i.e. adjacent cup opening 7, there is an opening-bordering outer coating 8 of a first end region 5, the coating extending over about ⅙ of the cup length, and an outer coating 9 bordering on the bottom 3, the coating extending again over about ⅙ of the cup length, and going over into an outer coating 10 of the bottom.

Between both outer coatings 8, 9, there remains a coating-free region 11 of about ⅔ of the cup length. The length ratios of the outer coatings 8,9, to the length of the not-coated region 11, can be greatly varied, according to requirements and technical specifications. Therefore, the lengths of the end region coatings 8, 9 can approximate 1/20 to ⅓ the entire axial length of the cup 1.

After the application of the coatings 4, 8 and 9, the entire cylindrical exterior surface, with the exception of the bottom exterior 10, is covered with an insulating layer, which is not shown in the drawing. This layer is a lacquer, an adhesive label or a plastic shrink-fit sleeve, or a combination of the foregoing.

The thickness of the coatings 4, 8 and 9 can be different inside and outside. Also, the coating materials of coatings 4, 8 and 9 can differ inside and outside.

The partial coating, in accordance with the invention, of the cup exterior, and the coating of the cup interior are particularly advantageously carried out with an installation as described in US patent disclosure 2006/0118411, SEEFELDT & GUSTAR.

Various changes and modifications are possible within the scope of the inventive concept.

What is claimed is:

1. A housing for a galvanic element as device battery comprising
a cylindrical outer cup (1) of metal, galvanically coated inside and outside with a metal plating, wherein
an outer coating (8, 9) is arranged only in respective end regions (5, 6) of the cup (1); and
an outer intermediate region (11) between the end regions is free of coating.

2. The housing according to claim 1,
wherein
the respective lengths of the end region coatings (8, 9) approximate 1/20 to ⅓ of the entire axial length of the cup (1).

3. The housing according to claim 1,
wherein
the thicknesses of the coatings (4, 8, 9) inside and outside are carried out differently.

4. The housing according to claim 1,
wherein
the coating materials of the coatings (4, 8, 9) inside and outside are different from each other.

5. The housing according to claim 1,
wherein
the exterior of the cup (1) is covered, over the entire length of the cup (1), up to the contacts, with an insulating layer, which also covers both end region coatings (8,9)

6. The housing according to claim 5, characterized in that
the insulating layer comprises a lacquer.

7. A method of making a housing for galvanic element comprising the steps of:
forming a cup of metal or plastic,
galvanically coating the cup is completely inside, and galvanically partly coating an exterior of the cup, such that only the two exterior end regions are coated, an intermediate region, between the end regions, remaining free of coating,
the lengths of the respective end region coatings (8,9) being about 1/20 to ⅓ of the entire axial length of the cup (1),
and
thereafter covering, the cup exterior , over the entire length of the cup, up to the contacts, with an insulating layer which also covers both end region coatings (8, 9).

8. The method of claim 7, wherein said coating step comprises plating on a layer of tin.

9. The method of claim 7, wherein said coating step comprises plating on a layer of nickel.

10. The method of claim 7, wherein said coating step comprises plating on a layer of cobalt.

11. The method of claim 7, wherein said coating step comprises plating on a layer of a nickel-containing alloy.

12. The method of claim 7, wherein said coating step comprises plating on a layer of a cobalt-containing alloy.

13. A housing for a galvanic element as device battery comprising
an outer cup (1) of plastic, galvanically coated inside and outside with a metal plating,
wherein
said metal plating (8, 9) is applied, on exterior surfaces of said cup, only in respective end regions (5, 6) of the cup (1); and
an outer intermediate region (11) between the end regions is kept free of coating.

14. The housing of claim 5, wherein said insulating layer comprises a self-adhering layer applied to a cylindrical exterior surface of said cup.

15. The housing of claim 5, wherein said insulating layer comprises a plastic layer which is shrunk to closely adhere to a cylindrical exterior surface of said cup.

16. The housing of claim 1, wherein said plating consists essentially of tin.

17. The method of claim 1, wherein said plating consists essentially of nickel.

18. The method of claim 1, wherein said plating consists essentially of cobalt.

19. The method of claim 1, wherein said plating consists essentially of a nickel-containing alloy.

20. The method of claim 1, wherein said plating consists essentially of a cobalt-containing alloy.
